(19) United States
(12) Patent Application Publication
(10) Pub. No.: US 2008/0295465 A1
(43) Pub. Date: Dec. 4, 2008

(54) Horse headcollar

(76) Inventor: Samantha Louise Kemp, Norwich (GB)

Correspondence Address: Thomas M. Galgano, 20 W. Park Avenue, Suite 204, Long Beach, NY, 11561, US

(21) Appl. No.: 12/070,765

(22) Filed: Feb. 21, 2008

(30) Foreign Application Priority Data
May 3, 2007 (GB) GB07 08532.7

(51) Int. Cl. B68B 1/02; B68B 1/00

(52) U.S. Cl. 54/71; 54/24

(57) ABSTRACT

A headcollar attachment for use in controlling or training a horse. The attachment contains a first clip releasably attachable to a first side of a headcollar and a second clip having a retention ring attached thereto. The attachment also contains a control rope. The rope is intended to pass around the nose and chin of a horse at a spaced distance from the headcollar towards the muzzle of the horse, and to form a loop with the rope passing through each retention ring, and whereby tensioning one end of the rope causes the rope to draw more tightly around the horse.

### FIELD OF THE INVENTION

The present invention relates to the control of horses. In particular, a headcollar, or headcollar attachment is disclosed to assist in training horses.

### BACKGROUND TO THE INVENTION

In order to effectively control or train animals such as horses or ponies a number of items of equipment is used. The below described invention is concerned with one of these items, namely the headcollar. A headcollar is normally utilised when the horse is not being ridden to assist in leading the horse from place to place.

The design of conventional headcollars is such that they can be worn throughout the day without discomfort to the horse. When required, a lead rope can be attached to the headcollar, which rope is used to pull the horse in the required direction.

Conventional headcollars comprise a headpiece or neckstrap passing over the back of the neck of the horse. The neckstrap is connected firstly to a throatlash which passes under the horse's throat and connects at either end with the headpiece to form a loop. The neckstrap is further connected to a noseband, which passes around the nose and under the chin, by means of cheek bands. Attachments are present on the headcollar to enable the lead rope to be secured. Although the headcollar is usually sufficient for well-trained horses or for situations in which the horse is not likely to find stressful it is sometimes necessary for the handler to be able to exert additional control. For example when dealing with a young horse or when trying to lead a horse into a trailer.

Such additional control has been disclosed in the prior art. For example additional collars can be added which pull down the back of the horse's neck are known, and applied particularly where a horse has a tendency to pull its head back. It is believed however that this means of control can cause too much discomfort to the horse.

A further means is disclosed in U.S. Pat. No. 4,337,610 which adapts a conventional headcollar by making the upper portion of the noseband of rigid construction whilst at the same time allowing the diameter of the noseband to be altered. The handler can then exert a clamping action around the horse's mouth. A rigid element around the horse's face is not however ideal as chafing or brushing could easily occur due to over tightening or from the horse pulling when nervous. This chafing or brushing is only likely to increase unwanted behaviour by the horse.

WO 94/14699 discloses a chinstrap, attachable to a headcollar which tightens under the chin of the horse. Again it is believed that this can cause unnecessary discomfort.

It is an object of the invention to address the above problems and provide a headcollar attachment to provide control with low discomfort to the animal. It is a further object of the invention to provide a headcollar to provide said control.

### SUMMARY OF THE INVENTION

According to a first aspect of the invention there is provided a headcollar attachment for use in controlling or training a horse, the attachment comprising a first clip releasably attachable to a first side of a headcollar and a second clip having a retention ring attached thereto, the attachment further comprising a control rope, the rope to pass around the nose and chin of a horse at a spaced distance from the headcollar towards the muzzle of the horse, the rope forming a loop, the rope passing through each retention ring, and whereby tensioning one end of the rope causes the rope to draw more tightly around the horse.

The invention provides a gentle means of applying pressure to the nose of the horse, causing the horse discomfort, thereby facilitating the control of the animal.

The rope is preferably an endless loop which passes double stranded through the retention rings. This gives additional strength to the rope and also spreads the pressure exerted on the horse thereby reducing the risk of chafing.

Advantageously, one end of the rope includes a retainer ring through which the second end of the rope passes, tensioning of said second end causing the rope to draw tight around the horse. The retaining ring allows tensioning and release of tension to be readily carried out by the handler.

Optionally a gripping means is attached to the second end of the rope to facilitate use thereof by the handler.

According to a second aspect of the invention there is provided a headcollar, said headcollar including a noseband, wherein the headcollar further comprises a control means to control a horse wearing the headcollar, said control means comprising a central rope at a spaced distance from the noseband towards the end of a horse's muzzle, the rope passing around the nose and chin of a horse at a spaced distance from the headcollar towards the muzzle of the horse, the rope forming a loop, the rope passing through each retention ring, and whereby tensioning one end of the rope causes the rope to draw more tightly around the horse.

### BRIEF DESCRIPTION OF THE DRAWINGS

The invention will now be described with reference to the accompanying drawings which show by way of example only, one embodiment of a training attachment for a headcollar. In the drawings:

FIG. 1 illustrates a prior art headcollar;

FIG. 2 illustrates a headcollar having an attachment in accordance with the invention; and

FIG. 3 illustrates a headcollar and attachment on a horse.

### DETAILED DESCRIPTION OF THE INVENTION

The invention as herein described is a trainer or controller suitable for attachment to standard headcollars well known in the art. Moreover, the trainer can be used with the three main sizes of horse, pony, cob and full size. As such, a single trainer can be used at different times for a large number of horses thereby bringing a cost saving to the user, as one or more examples for each size do not need to be kept in stock. In addition to this, due to the ease of removal and re-attachment, the same trainer can be used for a number of horses in a short space of time without having to switch trainers.

A typical prior art head collar 10 is shown in FIG. 1. The headcollar 10 comprises a headpiece 11, in the form of a strap, which passes in use over the neck of the horse behind the horse's ears. The free ends of the headpiece 11 are attached to rings 12, one ring on either side of the horse's head. Each end of a throat lash 13 is attached to a ring 12 such that the headpiece 11 and throat lash 13 together form a loop. A further constituent of the headcollar 10 is a noseband 14 which loops over the nose and under the chin of the horse. The noseband 14, on the headcollar shown is itself comprised of two sections, a nose strap 15 and a chin strap 16 which are joined together at either end by means of rings 17.

In order to secure the noseband 14 to the headpiece and throat lash assembly, a number of further straps are employed. Firstly, cheek straps 18, one on either side of the horse's head link the rings 12 and 17 together.

Secondly, a further throat strap 19 links the centres of the throat lash 13 and the chin strap 16 together. In order to allow the headcollar to be adjusted to fit the horse, buckles such as that shown at 20 are provided.

Typically the headcollars are made of leather or webbing material to provide a hardwearing product which is sufficiently flexible and soft so that the horse is not chafed.

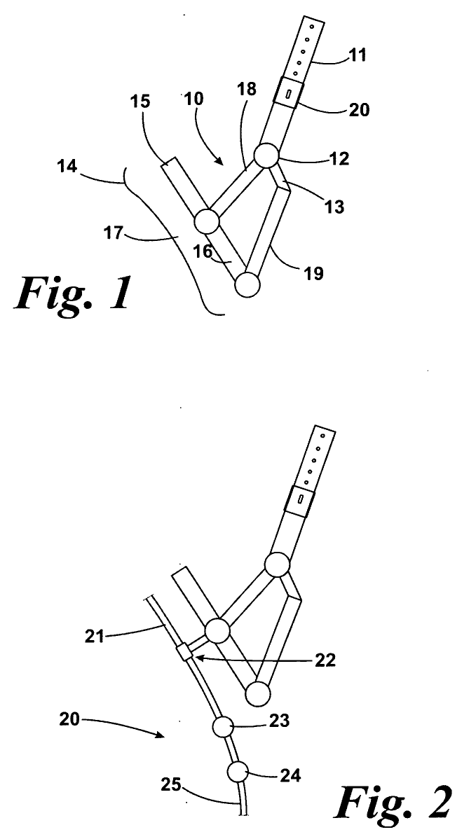

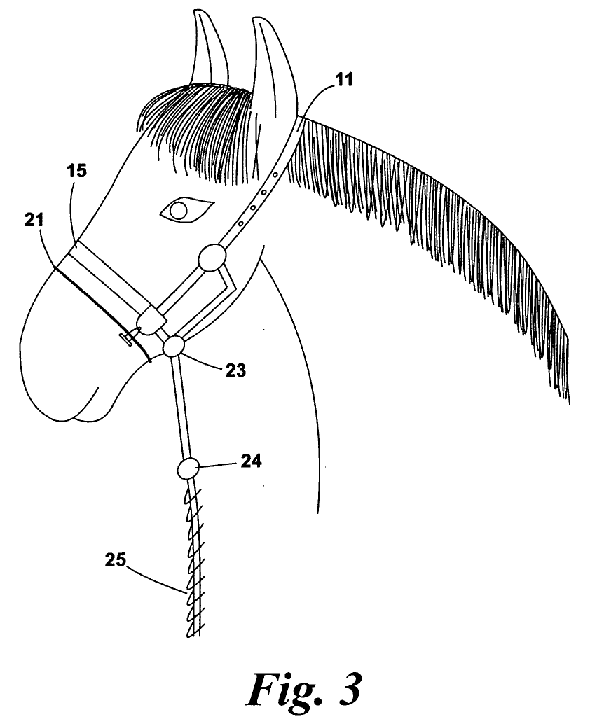

Turning now to FIGS. 2 and 3 these illustrate a trainer, for use in conjunction with the headcollar 10 of FIG. 1, which provides the handler with more effective control over a horse. The trainer 20 comprises a rope 21 formed into an endless loop. Releasable connectors 22 are clipped one either side of the horse's head, onto the rings 17. The connectors are elongate and have at their distal end a loop through which the rope 21 can pass and which allows the rope to freely move through the loop.

The rope 21, in use therefore passes through the loop on the first connector 22 over the nose of the horse and through the loop of the connector 22 on the other side of the horse's head. In doing so the two opposed sides of the loop of the rope 21 are retained in a close contiguous relationship such that the loop can be described as having a first and a second ‘free end’. A further ring 23 located around the rope 21 is slid to a first free end of the rope 21 and the second free end of the rope 21 is passed through the ring 23, under the horse's chin, so that the trainer 20 effectively encircles the horse's head. Due to the elongate nature of the connectors 22, the trainer 20 is held at a distance from the headcollar 10 towards the muzzle of the horse.

By applying tension to the second free end of the rope 21 the trainer 20 can be used to control the horse. Said tension causes the rope 21 to draw more tightly, albeit gently around the sensitive nose area of the horse.

Although this action does not hurt the horse it does cause discomfort and the tensioning and release of tension can be used to control or train the animal without causing harm.

To aid the handler in holding on to the second free end, a lead ring 24 can be included which also passes around the rope 21 and which can slide along the rope. In the embodiment shown in FIG. 2, the diameter of the lead ring 24 is small enough for it to be able to pass through the ring 23. A lead rope 25 can then be attached to the ring 24.

In a further embodiment the second free end of the rope 21 passes, not through a ring 23 but through the inside of the loop of the rope 21. A lead rope 24 can then be attached and used as described above. Although this embodiment works well, friction within the rope as tension is applied and released may have a slightly deleterious effect on the functioning of the trainer and may, due to friction lead to wear on the rope 21.

The above embodiments are described with reference to a rope formed into an endless loop prior to its being used. In an alternative embodiment a rope can be used having at a first end a ring 23. The rope passes through the loops on the connectors as described above, and the second end then passes through the ring 23, which can itself then be used as a lead rope or can have a lead rope attached: for example by including a ring at the second end to which a lead rope can be clipped or otherwise attached.

The examples shown above are described with reference to an attachment which can be readily attached and detached from a headcollar. In an alternative embodiment, not illustrated the trainer can be permanently attached to the headcollar to form a trainer headcollar. For example the detachable connectors 22 could be substituted by permanent connectors.

It will of course be understood that the invention is not limited to the specific details described herein, which are given by way of example only, and that various modifications and alterations are possible within the scope of the invention. For example, the material from which the trainer is constructed can be made of a soft leather which is both hard-wearing and not likely to cause the horse discomfort.

1. A headcollar attachment for use in controlling or training a horse, the attachment comprising:
a first clip releasably attachable to a first side of a headcollar;
a second clip having a retention ring attached thereto; and
a control rope, the rope to pass around the nose and chin of a horse at a spaced distance from the headcollar towards the muzzle of the horse, the rope forming a loop, the rope passing through each retention ring, and whereby tensioning one end of the rope causes the rope to draw more tightly around the horse.

2. A headcollar according to claim 1, wherein the rope is an endless loop which passes double stranded through the retention rings.

3. A headcollar according to claim 1, wherein one end of the rope includes a retainer ring through which the second end of the rope passes, tensioning of said second end causing the rope to draw more tightly around the horse.

4. A headcollar according to claim 1, wherein a gripping means is attached to the second end of the rope to facilitate use thereof by the handler.

5. A headcollar including a noseband, wherein the headcollar further comprises a control means to control a horse wearing the headcollar, said control means comprising a central rope at a spaced distance from the noseband towards the end of a horse's muzzle, the rope passing around the nose and chin of a horse at a spaced distance from the headcollar towards the muzzle of the horse, the rope forming a loop, the rope passing through each retention ring, and whereby tensioning one end of the rope causes the rope to draw more tightly around the horse.

6. A headcollar according to claim 2, wherein one end of the rope includes a retainer ring through which the second end of the rope passes, tensioning of said second end causing the rope to draw more tightly around the horse.
